(19) United States
(12) Patent Application Publication
(10) Pub. No.: US 2012/0103001 A1
(43) Pub. Date: May 3, 2012

(54) ILLUMINATED DISPENSING TARGET FOR DISPENSER RECESS AND REFRIGERATION APPLIANCE INCORPORATING SAME

(75) Inventors: Andrew Reinhard Krause, LaGrange, KY (US); Christopher George Bissig, Louisville, KY (US); Lorina June White, Louisville, KY (US); Jarvis Ward, Louisville, KY (US); Jose Tomas DeLuna, Allen Park, MI (US); David C. Calvert, Mount Sterling, KY (US)

(73) Assignee: GENERAL ELECTRIC COMPANY, Schenectady, NY (US)

(21) Appl. No.: 12/917,734

(22) Filed: Nov. 2, 2010

(51) Int. Cl. F25D 3/00; F25D 27/00; G02B 6/00; B67D 7/86; F21V 33/00

(52) U.S. Cl. 62/389; 222/113; 362/96; 362/551; 362/92

(57) ABSTRACT

An illuminated dispenser assembly for a consumer appliance panel includes a dispenser recess area located in the panel. The dispenser recess area is defined by walls including a bottom wall, a back wall and a top wall. The bottom wall has a top surface. A dispenser is located in the panel. The dispenser has an outlet extending through one of the walls of the dispenser recess area to dispense a substance from an interior of the consumer appliance to the dispenser recess via the outlet. A lighting element includes a light source located below the top surface of the bottom wall for illuminating a target area in the bottom wall of the dispenser recess. The target area is located relative to the dispenser outlet so as to identify a location for placement of a receptacle for receiving the substance from the dispenser. A related refrigeration appliance incorporating such an illuminated dispensing target is also disclosed.

### FIELD OF THE INVENTION

The subject matter disclosed herein relates generally to providing a container location indicator to a user of a dispenser, such as those found in consumer appliances, including refrigeration appliances.

### BACKGROUND OF THE INVENTION

Dispensers for liquids or ice have been provided in consumer appliances such as refrigerators, freezers, and vending machines. In certain of such devices, both hot and cold water may be provided. In some devices, coffee or other beverages may be dispensed as well. Often, these dispensers include some sort of recess or compartment into which a container such as a cup is placed to receive the substance.

Lighting may be provided for the compartment to assist the user in placing the container so as to receive the substance. Typically, such lighting is an incandescent bulb placed in a top portion of the compartment. While such a bulb will generally illuminate the compartment sufficiently, such a bulb can not provide much information to a user. Also, aesthetically, such a bulb is somewhat limited. Further, such conventional illumination does not assist a user in properly locating a container for receipt of the dispensed substance so as to avoid spillage.

Accordingly, improved lighting devices and systems for dispenser recesses would be welcome.

### BRIEF DESCRIPTION OF THE INVENTION

Aspects and advantages of the invention will be set forth in part in the following description, or may be obvious from the description, or may be learned through practice of the invention.

According to certain aspects of the disclosure, an illuminated dispenser assembly is disclosed for a consumer appliance panel, the assembly including a dispenser recess area located in the panel. The dispenser recess area is defined by walls including a bottom wall, a back wall and a top wall. The bottom wall has a top surface. A dispenser is located in the panel. The dispenser has an outlet extending through one of the walls of the dispenser recess area to dispense a substance from an interior of the consumer appliance to the dispenser recess via the outlet. A lighting element includes a light source located below the top surface of the bottom wall for illuminating a target area in the bottom wall of the dispenser recess. The target area is located relative to the dispenser outlet so as to identify a location for placement of a receptacle for receiving the substance from the dispenser. Various options and modifications are possible.

According to certain other aspects of the disclosure, a refrigeration appliance includes a refrigerated compartment having a door and a dispenser recess area located in the door. The dispenser recess area is defined by walls including a bottom wall, a back wall and a top wall. The bottom wall has a top surface. A dispenser is located in the door. The dispenser has an outlet extending through one of the walls of the dispenser recess area to dispense a substance from an interior of the door to the dispenser recess via the outlet. A lighting element includes a light source located below the top surface of the bottom wall for illuminating a target area in the bottom wall of the dispenser recess. The target area is located relative to the dispenser outlet so as to identify a location for placement of a receptacle for receiving the substance from the dispenser. As above, various options and modifications are possible.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a refrigeration appliance with its doors closed;

FIG. 2 provides a front view of the refrigeration appliance of FIG. 1 with its doors opened;

FIG. 3 provides a close up view of a dispenser portion of the refrigeration appliance of FIG. 1;

FIG. 4 provides a view as in FIG. 3, with a receptacle in a target area in the bottom wall for receiving a substance from an outlet;

FIG. 5 provides a top view of the bottom wall of the dispenser portion of FIG. 3;

FIG. 6 provides a cross-sectional view of the bottom wall taken along line 6-6 in FIG. 5;

FIG. 7 provides a cross-sectional view of the bottom wall taken along line 7-7 in FIG. 5;

FIG. 8 provides a cross-sectional view of an alternate bottom wall;

FIG. 9 provides a cross-sectional view of another alternate bottom wall taken along line 9-9 in FIG. 10;

FIG. 10 provides a top view of the alternate bottom wall shown in FIG. 9;

FIG. 11 provides a cross-sectional view of another alternate bottom wall taken along line 11-11 in FIG. 12; and

FIG. 12 provides a top view of the alternate bottom wall shown in FIG. 11.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

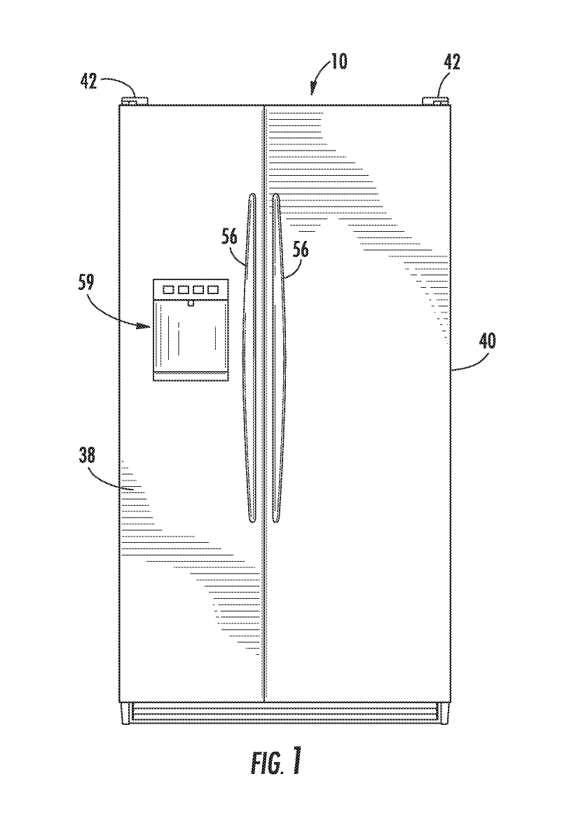

FIG. 1 is a perspective view of an exemplary refrigeration appliance 10 depicted as a refrigerator in which dispenser target indicating assemblies in accordance with aspects of the present invention may be utilized. It should be appreciated that the appliance of FIG. 1 is for illustrative purposes only and that the present invention is not limited to any particular type, style, or configuration of refrigeration appliance, and that such appliance may include any manner of refrigerator, freezer, refrigerator/freezer combination, and so forth.

Referring to FIG. 2, the refrigerator 10 includes a fresh food storage compartment 12 and a freezer storage compartment 14, with the compartments arranged side-by-side and contained within an outer case 16 and inner liners 18 and 20 generally molded from a suitable plastic material. In smaller refrigerators 10, a single liner is formed and a mullion spans between opposite sides of the liner to divide it into a freezer storage compartment and a fresh food storage compartment. The outer case 16 is normally formed by folding a sheet of a suitable material, such as pre-painted steel, into an inverted U-shape to form top and side walls of the outer case 16. A bottom wall of the outer case 16 normally is formed separately and attached to the case side walls and to a bottom frame that provides support for refrigerator 10.

A breaker strip 22 extends between a case front flange and outer front edges of inner liners 18 and 20. The breaker strip 22 is formed from a suitable resilient material, such as an extruded acrylo-butadiene-styrene based material (commonly referred to as ABS). The insulation in the space between inner liners 18 and 20 is covered by another strip of suitable resilient material, which also commonly is referred to as a mullion 24 and may be formed of an extruded ABS material. Breaker strip 22 and mullion 24 form a front face, and extend completely around inner peripheral edges of the outer case 16 and vertically between inner liners 18 and 20.

Slide-out drawers 26, a storage bin 28 and shelves 30 are normally provided in fresh food storage compartment 12 to support items being stored therein. In addition, at least one shelf 30 and at least one wire basket 32 are also provided in freezer storage compartment 14.

The refrigerator features are controlled by a controller 34 according to user preference via manipulation of a control interface 36 mounted in an upper region of fresh food storage compartment 12 and coupled to the controller 34. As used herein, the term “controller” is not limited to just those integrated circuits referred to in the art as microprocessor, but broadly refers to computers, processors, microcontrollers, microcomputers, programmable logic controllers, application specific integrated circuits, and other programmable circuits, and these terms are used interchangeably herein.

A freezer door 38 and a fresh food door 40 close access openings to freezer storage compartment 14 and fresh food storage compartment 12. Each door 38, 40 is mounted by a top hinge 42 and a bottom hinge (not shown) to rotate about its outer vertical edge between an open position, as shown in FIG. 1, and a closed position. The freezer door 38 may include a plurality of storage shelves 44 and a sealing gasket 46, and fresh food door 40 also includes a plurality of storage shelves 48 and a sealing gasket 50.

The freezer storage compartment 14 may include an automatic ice maker 52 and a dispenser 54 provided in the freezer door 38 such that ice and/or chilled water can be dispensed without opening the freezer door 38, as is well known in the art. Doors 38 and 40 may be opened by handles 56 is conventional. A housing 58 may hold a water filter 60 used to filter water for the ice maker 52 and/or dispenser 54.

As with known refrigerators, the refrigerator 10 also includes a machinery compartment (not shown) that at least partially contains components for executing a known vapor compression cycle for cooling air. The components include a compressor, a condenser, an expansion device, and an evaporator connected in series as a loop and charged with a refrigerant. The evaporator is a type of heat exchanger which transfers heat from air passing over the evaporator to the refrigerant flowing through the evaporator, thereby causing the refrigerant to vaporize. The cooled air is used to refrigerate one or more refrigerator or freezer compartments via fans. Also, a cooling loop can be added to direct cool the ice maker to form ice cubes, and a heating loop can be added to help remove ice from the ice maker. Collectively, the vapor compression cycle components in a refrigeration circuit, associated fans, and associated compartments are conventionally referred to as a sealed system. The construction and operation of the sealed system are well known to those skilled in the art.

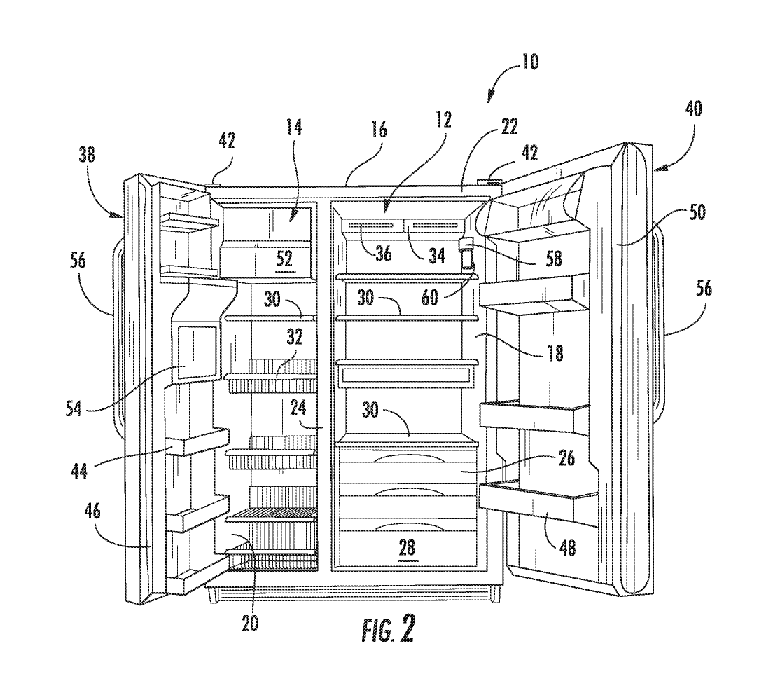

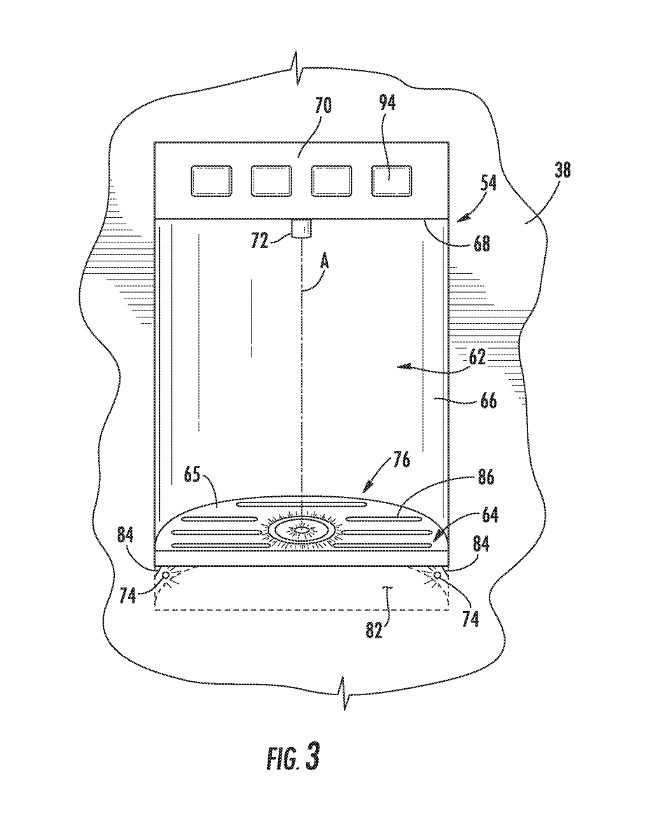

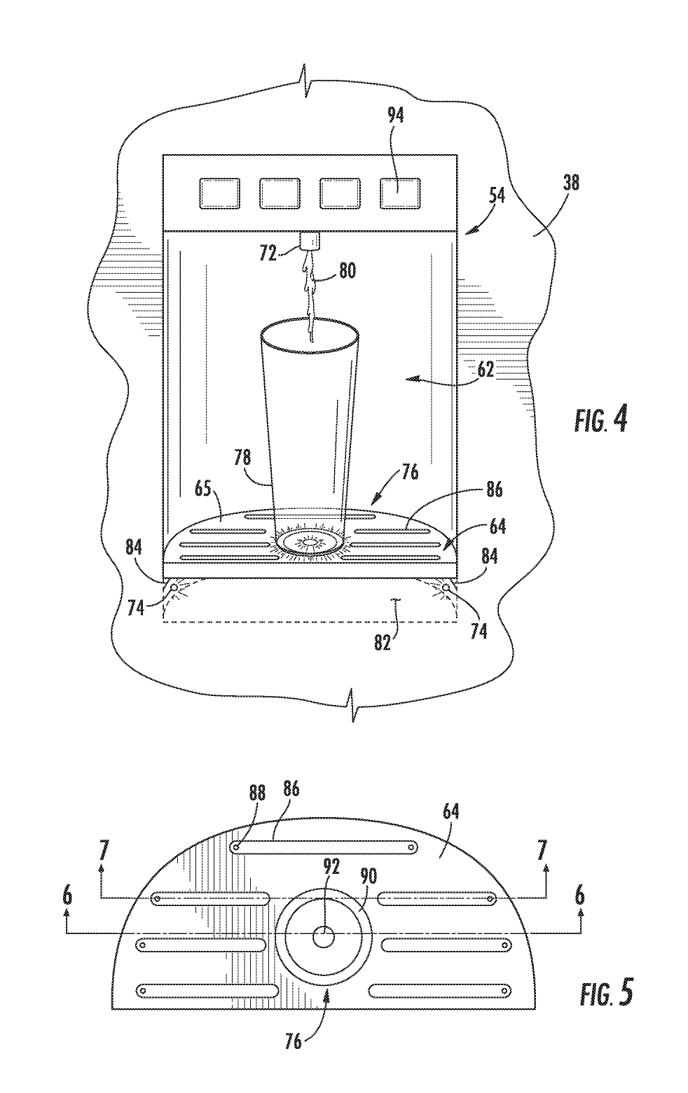

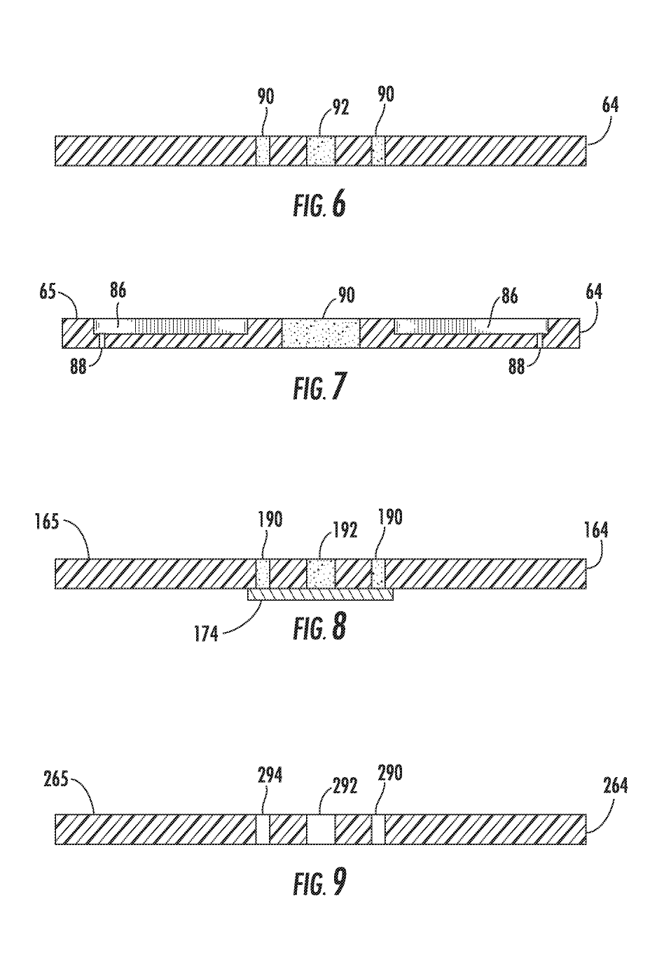

FIGS. 3 and 4 show details of one example of a dispenser 54 suitable for use on a consumer appliance of any sort, such as refrigeration appliance 10. Dispenser 54 could also be used in a device such as a vending machine, cafeteria, home, office, etc. Therefore, in its broadest sense, dispenser 54 can be employed in various locations, and certainly not just on a typical home refrigerator or the like.

As shown, a dispenser recess area 62 is defined in door 38. Dispenser recess 62 includes a bottom wall 64, a back wall 66, and a top wall 68. Bottom wall 64 includes a top surface 65. As shown, back wall 66 is curved, forming a somewhat partial cylindrical surface. It should be understood that any back wall shape and profile, including multiple walls (two sides and a back, for example) could be employed. Further, top wall 68 may be partial, covered by or constituting a façade 70, for example. Therefore, the number and orientation of walls forming dispenser recess 62 is not limiting.

At least one dispenser outlet 72 extends into dispenser recess 62 for dispensing a substance from an interior of door 38. Multiple of such dispenser outlets could be provided if desired, either separated or adjacent. The dispenser outlet or outlets 72 may dispense ice cubes, ground ice cubes, chilled water, warm water, hot water, etc. If dispenser 54 is in a device other than a refrigeration appliance, the outlets may dispense food or drink, or any other item.

At least one lighting element including a light source 74 is provided for illuminating (from below) a target area 76 in bottom wall 64 of dispenser recess 62. As shown, light source 74 is located below top surface 65 of bottom wall 64. Light source 74 may be one or more elements such as conventional LED's, LCD's, OLED's, or other bulbs. Light sources 74 may be of a single color, may provide multiple colors selectively, or may have multiple elements of differing colors selectively activatable as desired for functionality and/or aesthetics.

Target area 76 is located in substantial alignment with outlet 72 so as to identify a preferred location to a user for placement of a receptacle 78 such as a cup for receiving a dispensed substance 80. Line A through outlet 72 and target area 76 shows that both are aligned.

Floor surfaces of dispenser openings such as bottom wall 64 may be removable for cleaning and the like. Accordingly, light source 74 can be provided in a sump area 82 below bottom wall 64, thereby allowing the bottom wall to be removed for cleaning without having to move anything electronic. Sump area 82 may lead to a drain or simply be a location from which evaporation or manual removal of liquids may occur. Supports 84 may be provided to hold bottom wall 64 in place above sump area. However, bottom wall 64 may be fixed in place in this or other embodiments.

Bottom wall 64 may include indentations 86 of various shapes and orientations in its top surface to capture any liquids or melted ice that may miss receptacle 78. If desired, small drain holes 88 may be provided for passage of liquids into sump area 82 (see FIG. 7).

Bottom wall target area 76 may also include at least one partially translucent indicating element 90. As shown, an annular indicating element 90 is provided in bottom wall 64. Indicating element 90 is formed as a molded-in piece within bottom wall 64, although it could be separately formed and attached. As such, indicating element 90 may be a plastic such as an acrylic that is at least partially translucent, wholly translucent, or transparent. Indicating element 90 may additionally have a color such as red, blue, etc., if desired.

When light source 74 is illuminated, indicating element 90 receives and transmits light from light source 74 to inform the user as to where a receptacle should be placed to receive a dispensed substance. Thus, indicating element 90 forms at least a portion of target area 76. Multiple parts could be employed, such as circular indicating element 92 at the center of target area 76. Accordingly, any number, shape or orientation of indicating elements could be used to indicate to the user the target area. The different indicating elements could have identical and symmetrical shapes or they could be differently shaped and spaced. The indicating elements could also have differing colors.

The lighting element can be lit in various ways to provide various functional and aesthetic benefits. For example, a controller such as within controller 34 or elsewhere can provide various lighting scenarios. If a user operates a user input device such as a button 94, (or a conventional touch pad, paddle, etc., not shown) on dispenser 54, a signal can be sent to the controller 34 to operate or change the operational state of the lighting element in some way.

Therefore, if a user desires cold water and presses a button 94 corresponding to that, controller 34 can cause light source 74 to go from a first state to a second state (for example, from not lit up to a lighted state), thereby illuminating the indicating elements 90,92 in target area 76. If desired, light sources 74 can be lit up, lit up intermittently instead of constantly, or can go from one brightness level to another, one color to another, combinations of these, etc. Controller 34 can therefore cause lighting element to change state in any of various ways to highlight the target area. This type of illumination may vary depending on the user's choice and/or which button 94 was pressed. For example, cold water could receive a blue indication, warm water a red indication, and ice cubes a white indication, and ground ice an intermittent flashing white indication, as just one example.

FIG. 8 shows a modified version of bottom wall 64. As shown, bottom wall 164 includes a lighting element 174 attached to its bottom surface adjacent indicating elements 190, 192. Lighting element could be an OLED or LCD panel, for example, that could be controlled in any way described above to illuminate indicating elements 190, 192 as desired.

FIGS. 9 and 10 show another alternate bottom wall 264 in which indicating elements are openings 290, 292, 294 formed through the bottom wall in target area 276. In this embodiment, light sources below bottom wall 264 provide light sufficient to illuminate the target area 276 without the need for a translucent or transparent material to guide light upward; openings 290, 292, 294 do so without materials therein.

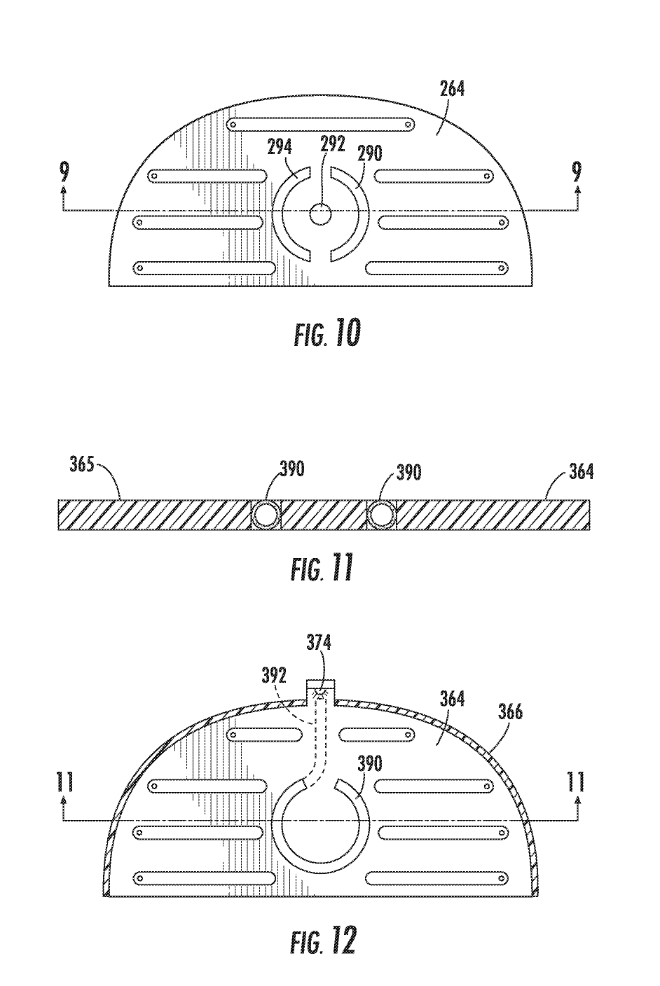

FIGS. 11 and 12 show an alternate bottom wall 364 in which indicating element 390 is formed from a light pipe element, such as an optical fiber, acrylic, polyurethane, or other optical rod or tube for transmitting light. Light pipe 390 may be press-fit into bottom wall 364 if desired, and prisms, lenses or other focusing materials (not shown) may be provided to assist in transferring light from light source 374 to light pipe 390 to form target area 376. Light source 374 may be located near a portion 392 of light pipe 390 located beneath top surface 365 of bottom wall 364. Therefore, to make a more pleasing or informative shape for target 376, portion 392 may be covered by a portion of top surface 365. Light source 374 may thus be located beneath top surface 365 and possibly behind or attached to back wall 366. Bottom wall 364 may be fixed in place or removable if desired. Objects considered light pipes here include light sources available from companies such as 3M under the trade names Precision Lighting Element or Light String, or other companies. Light pipes receive light from a light source and transmit the light along their length in either a tube or rod form. Light pipes may be straight, permanently bent, or flexibly bendable. Therefore, a particular type or source of light pipe should not be considered limiting or required under the invention.

Accordingly, in view of the above an assembly suitable for but not limited to use with a refrigeration appliance is provided in which a dispenser target area can be illuminated from below to provide a functional and/or aesthetically pleasing display to a user. Spillage of dispensed substances, cleaning, etc. is therefore reduced, providing a further improved consumer experience. While this disclosure is directed to push button type operation, the invention is not limited to such. Accordingly, mechanical paddle or other dispenser triggering devices within the dispenser recess or otherwise are also possible.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An illuminated dispenser assembly for a consumer appliance panel, the assembly comprising:
a dispenser recess area located in the panel, the dispenser recess area being defined by walls including a bottom wall, a back wall and a top wall, the bottom wall having a top surface;
a dispenser located in the panel, the dispenser having an outlet extending through one of the walls of the dispenser recess area to dispense a substance from an interior of the consume appliance to the dispenser recess via the outlet; and
a lighting element including a light source located below the top surface of the bottom wall for illuminating a target area in the bottom wall of the dispenser recess, the target area being located relative to the dispenser outlet so as to identify a location for placement of a receptacle for receiving the substance from the dispenser.

2. The assembly of claim 1, wherein the lighting element includes at least one at least partially translucent indicating element arranged in the bottom wall transmitting light from the light source, the indicating element indicating the location of at least a portion of the target area.

3. The assembly of claim 2, wherein the indicating element includes a light pipe.

4. The assembly of claim 2, wherein the indicating element includes a transmissive material molded into the bottom wall.

5. The assembly of claim 1, wherein the light source include at least one of an LED, LCD, OLED, or bulb.

6. The assembly of claim 1, further including a controller for placing the lighting element in either a first state or in a second state.

7. The assembly of claim 6, wherein the controller causes the lighting element to be in the first state if the dispenser is idle and the second state if the dispenser is in operation.

8. The assembly of claim 6, wherein the first state is non-illumination and the second state is illumination.

9. The assembly of claim 6, wherein the first state is constant illumination and the second state is intermittent illumination.

10. The assembly of claim 6, wherein the first state is illumination with a first color and the second state is illumination with a second color.

11. The assembly of claim 10, wherein the first color corresponds to a first temperature of the dispensed substance and the second color corresponds to a second temperature of the dispensed substance.

12. The assembly of claim 10, wherein the dispenser dispenses a first substance and a second substance, the first color corresponding to the first dispensed substance and the second color corresponding to the second dispensed substance.

13. The assembly of claim 6, further including a user input device in communication with the controller for generating a signal based on input from the user as to a desired dispensed substance, the controller causing the lighting element to go from the first state to the second state based on the signal from the user input device.

14. A refrigeration appliance comprising:
a refrigerated compartment having a door;
a dispenser recess area located in the door, the dispenser recess area being defined by walls including a bottom wall, a back wall and a top wall, the bottom wall having a top surface;
a dispenser located in the door, the dispenser having an outlet extending through one of the walls of the dispenser recess area to dispense a substance from an interior of the door to the dispenser recess via the outlet; and
a lighting element including a light source located below the top surface of the bottom wall for illuminating a target area in the bottom wall of the dispenser recess, the target area being located relative to the dispenser outlet so as to identify a location for placement of a receptacle for receiving the substance from the dispenser.

15. The refrigeration appliance of claim 14, further including a controller for placing the lighting element in either a first state or in a second state and a user input device located on the outside of the door in communication with the controller for generating a signal based on input from the user as to a desired dispensed substance, the controller causing the lighting element to go from the first state to the second state based on the signal from the user input device.

16. The refrigeration appliance of claim 15, wherein the controller causes the lighting element to be in the first state if the dispenser is idle and the second state if the dispenser is in operation.

17. The refrigeration appliance of claim 14, wherein the lighting element includes at least one at least partially translucent indicating element arranged in the bottom wall transmitting light from the light source, the indicating element indicating the location of at least a portion of the target area.

18. The refrigeration appliance of claim 17, wherein the indicating element includes a light pipe.

19. The refrigeration appliance of claim 17, wherein the indicating element includes a transmissive material molded into the bottom wall.

20. The refrigeration appliance of claim 14, wherein the light source include at least one of an LED, LCD, OLED, or bulb.
